(19) United States
(12) Patent Application Publication
(10) Pub. No.: US 2021/0180435 A1
(43) Pub. Date: Jun. 17, 2021

(54) METHODS AND MATERIALS FOR PRODUCING IDENTIFIABLE METHANOGENIC PRODUCTS

(71) Applicant: Transworld Technologies Inc., Golden, CO (US)

(72) Inventors: Daniel Edward Connors, Denver, CO (US); Joseph Edward Zemetra, Lakewood, CO (US)

(73) Assignee: Transworld Technologies Inc., Golden, CO (US)

(21) Appl. No.: 16/713,407

(22) Filed: Dec. 13, 2019

(51) Int. Cl. E21B 43/16; C09K 8/594

(52) U.S. Cl. CPC E21B 43/164; C09K 8/594; E21B 43/168

(57) ABSTRACT

Methods of producing hydrocarbon materials from a geologic formation may include accessing a consortium of microorganisms in a geologic formation that includes a carbonaceous material. The methods may include delivering an aqueous material incorporating deuterium oxide to the consortium of microorganisms. The methods may include increasing production of hydrocarbon materials by the consortium of microorganisms. The methods may include recovering a deuterium-containing hydrocarbon from the geologic formation.

### TECHNICAL FIELD

The present technology relates to conversion material recovery. More specifically, the present technology relates to enhanced biological methane generation and identification.

### BACKGROUND

Increasing world energy demand is creating unprecedented challenges for recovering energy resources, and mitigating the environmental impact of using those resources. Some have argued that the worldwide production rates for oil and domestic natural gas will peak within a decade or less. Once this peak is reached, primary recovery of oil and domestic natural gas will start to decline, as the most easily recoverable energy stocks start to dry up. Historically, old oil fields and coal mines are abandoned once the easily recoverable materials are extracted.

As worldwide energy prices continue to rise, it may become economically viable to extract additional oil and coal from these formations with conventional drilling and mining techniques. However, a point will be reached where more energy is required to recover the resources than can be gained by the recovery. At that point, traditional recovery mechanisms will become uneconomical, regardless of the price of energy.

Thus, there remains a need for improved methods of recovering oil and other carbonaceous materials from formation environments. There also remains a need for methods of introducing chemical amendments to a geologic formation that will stimulate the biogenic production of methane, which may be used as an alternative source of natural gas for energy production independent of the original reserve of the energy material. These and other needs are addressed by the present technology.

### SUMMARY

Methods of producing hydrocarbon materials from a geologic formation may include accessing a consortium of microorganisms in a geologic formation that includes a carbonaceous material. The methods may include delivering an aqueous material incorporating deuterium oxide to the consortium of microorganisms. The methods may include increasing production of hydrocarbon materials by the consortium of microorganisms. The methods may include recovering a deuterium-containing hydrocarbon from the geologic formation.

In some embodiments, the deuterium-containing hydrocarbon may be or include a deuterium-containing methane. The methods may also include determining an amount of newly produced gaseous materials. The determining may include identifying a concentration of deuterium within in-situ hydrocarbons prior to delivering the aqueous material. The determining may include identifying a concentration of deuterium within recovered hydrocarbons. The determining may include determining an amount of hydrocarbons resulting from increasing production of the hydrocarbon materials. The methods may include differentiating between ¹³CH₄ and DCH₃ within the hydrocarbons. The differentiating may be performed with isotope ratio mass spectrometry or cavity ring down spectroscopic detection. The aqueous material may also include incorporated metals. The incorporated metals may include one or more of cobalt, copper, manganese, molybdenum, nickel, tungsten, or zinc. The aqueous material may also include yeast extract. The aqueous material may include a phosphorous-containing compound. The geologic formation may be a coal bed, and the aqueous material may be delivered into a cleat characterized by a sub-bituminous coal maturity.

Some embodiments of the present technology may encompass methods of producing hydrocarbon materials from a geologic formation. The methods may include accessing a consortium of microorganisms in a geologic formation that includes a carbonaceous material. The methods may include determining a concentration of deuterium of in-situ methane within the geologic formation. The methods may include delivering an aqueous material incorporating a deuterium-containing compound to the consortium of microorganisms. The methods may include increasing production of methane by the consortium of microorganisms. The methods may include recovering a deuterium-containing methane from the geologic formation.

In some embodiments, the methods may include determining a concentration of deuterium in the recovered deuterium-containing methane. The methods may include determining a volume of new methane produced by the method. The geologic formation may be a deposit including oil, natural gas, coal, bitumen, tar sands, lignite, peat, carbonaceous shale or sediments rich in organic matter. The methods may include differentiating between ¹³CH₄ and DCH₃ within the deuterium-containing methane. The aqueous material may include incorporated metals, yeast extract, or a phosphorus-containing compound.

Some embodiments of the present technology may encompass methods of producing hydrocarbon materials from a geologic formation. The methods may include accessing a consortium of microorganisms in a geologic formation that includes a carbonaceous material. The methods may include determining within the geologic formation a concentration of a material including a naturally occurring, stable isotope for one or more of the elements carbon, hydrogen, oxygen, nitrogen, or sulfur of in-situ methane. The methods may include delivering to the consortium of microorganisms an aqueous material incorporating a compound including the stable isotope for the one or more of the elements carbon, hydrogen, oxygen, nitrogen, or sulfur. The methods may include increasing production of a compound by the consortium of microorganisms. The methods may include recovering from the geologic formation the material produced including the stable isotope for the one or more of the elements carbon, hydrogen, oxygen, nitrogen, or sulfur.

In some embodiments the compound may be or include water, and the stable isotope may be or include ²H or ¹⁸O. The compound may be or include carbon dioxide, and the stable isotope may be or include ¹³C or ¹⁸O. The compound may be or include molecular hydrogen, and the stable isotope may be or include ²H. The compound may be acetic acid or its conjugate base, and the stable isotope may be or include ²H or ¹³C. The produced material may be or include methane, carbon dioxide, or hydrogen that includes the stable isotope.

Such technology may provide numerous benefits over conventional systems and techniques. For example, by producing and extracting new and identifiable methanogenic products, a renewable energy source may be produced. Additionally, by utilizing non-radioactive isotopes, safer production and recovery may occur. These and other embodiments, along with many of their advantages and features, are described in more detail in conjunction with the below description and attached figures.

### BRIEF DESCRIPTION OF THE DRAWINGS

A further understanding of the nature and advantages of the disclosed technology may be realized by reference to the remaining portions of the specification and the figures.

FIG. 1 is a flowchart illustrating exemplary operations in a method of producing hydrocarbon materials from a geologic formation according to some embodiments of the present technology.

FIG. 2 is a flowchart illustrating exemplary operations in a method of producing hydrocarbon materials from a geologic formation according to some embodiments of the present technology.

FIG. 3 is a chart illustrating a DNA sequencing profile for a microbial community within a formation environment according to some embodiments of the present technology.

FIG. 4 is a chart illustrating a DNA sequencing profile for a microbial community within a formation environment according to some embodiments of the present technology.

### DETAILED DESCRIPTION

Biological methane generation is a common source of methane in hydrocarbon bearing formations. In coal-bed methane fields, the gas present is frequently if not exclusively the result of biological degradation of the coal, producing methane with specific characteristics that would be nearly identical to gas produced in non-geologic time periods as a result of stimulated methanogenesis, and that was also produced by the biological degradation of coal or other carbonaceous materials. In attempting to qualify a renewable source of natural gas, differentiating between existing gas and newly produced gas may be needed.

In order to demonstrate a measurable difference between existing and newly produced gas, either a characteristic of the new gas must measurably differ from the gas in place, or the rate of gas production has to deviate measurably from expected values. Historically, a decline curve analysis has provided evidence of new gas by showing deviations from a forecast that could not be explained by other reasons, such as field operation changes, workovers, etc. However, the specific quantities of newly produced gas are calculated, as is the amount of gas migration, from a coal-bed methane well receiving a treatment to an offset. An indirect method of origin assignment such as decline analysis may be insufficient for regulators or business personnel seeking to definitively discriminate between new renewable gas volumes and existing, non-renewable gas volumes.

The present technology may afford discrimination between new and old gas by modifying a measurable characteristic of new gas produced. This may occur by providing a treatment material for stimulating methanogenesis, where the material provided may include one or more compounds including a naturally occurring, stable isotope for one or more elements of a product or byproduct to be produced, whether that product or byproduct may be or include newly produced methane, hydrogen, carbon dioxide, acetic acid or its conjugate base, or any other material or intermediate material associated with methanogenic activity.

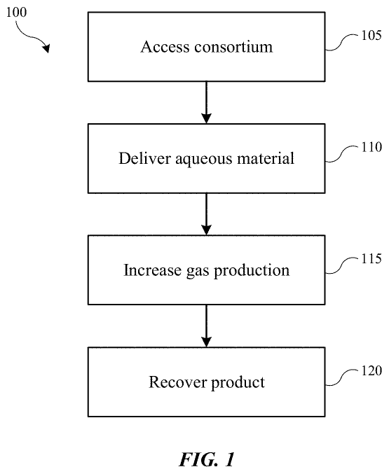

FIG. 1 illustrates a method 100 of producing hydrocarbon or other materials from a geologic formation. The method is designed to stimulate a consortium of microorganisms in the geologic formation to produce methane and other byproducts that may incorporate within or be utilized by microorganisms that may consume materials or be stimulated by materials to produce methane. The methods performed may stimulate and/or activate a consortium in the formation to start producing methane, and may increase production of an amount of methane that may be naturally formed within the environment. The methods may further include stopping or decreasing a “rollover” effect such as when the concentration of methane or other metabolic products starts to plateau after a period of monotonically increasing. These and other stimulation effects may be promoted by the materials delivered to the environment according to the method.

The method 100 may include accessing a consortium of microorganisms within the geologic formation at operation 105. The microorganisms may reside in oil, formation water, in a biofilm on a solid surface, or at an interface between any of these surfaces. In some embodiments the geologic formation may be a carbonaceous material-containing subterranean formation, such as a coal deposit, natural gas deposit, carbonaceous shale, bitumen, tar sands, lignite, peat, other sediments rich in organic matter, or other naturally occurring carbonaceous material. In some embodiments the geologic formation may be a non-carbonaceous material having a pore structure containing water that may include inorganic carbon content in the form of carbonates and ionic forms of carbon dioxide. In many of these instances, access to the formation can involve utilizing previously mined or drilled access points to the formation, such as a well, for example. For unexplored formations, accessing the formation may involve digging or drilling through a surface layer to access the underlying site where the microorganisms may be located.

Once access to the microorganisms in the formation is available, an aqueous material may be provided to the microorganisms at operation 110. In some embodiments an optional transfer of one or more materials may occur from the formation environment, such as into a bioreactor, or a bioreactor may be formed underground with materials. Material transfer may occur under controlled conditions, such as under anaerobic conditions, which may protect microorganisms. Once the material has been transferred, the aqueous material may be delivered to a sealed bioreactor or ex-situ environment. The aqueous material may be a water or other fluid injection, and in embodiments of the present technology, the aqueous material may be modified to incorporate a compound including a stable isotope of one or more of the elements carbon, hydrogen, oxygen, nitrogen, or sulfur. At operation 115, production of gaseous materials by the consortium of microorganisms may be increased through metabolizing materials within the aqueous material. These gaseous materials may be or include methane or other hydrocarbons, carbon dioxide, hydrogen, as well as other intermediate materials, which may not be gaseous, such as acetic acid or its conjugate base, for example. At operation 120, a product may be recovered from the formation environment, and the product may be characterized by including the stable isotope provided in operation 110 for the one or more elements carbon, hydrogen, oxygen, nitrogen, or sulfur. For example, the compound including the stable isotope may affect or be consumed by microorganisms within the formation environment, the compound may then be transferred or transformed into a product or byproduct including the stable isotope.

The aqueous material may be or include water in some embodiments, and the water may be modified to one or more materials within the fluid, including a compound including the stable isotope of the elements carbon, hydrogen, oxygen, nitrogen, sulfur, or other materials. A simple biological transformation that can be used to result in “new” methane is the acetoclastic methanogenesis pathway. In one pathway, one acetate ion is converted to one methane and one carbon dioxide. The carbon marked in the equation below with a * is always the carbon that ends up as methane.

*CH₃COO—_{(aq)}→(biological transformation)→*CH_{4(g)}+CO_{2(g)}

In one method, a radioactive isotope 14c may be used on labeled precursor molecules, and thus, if biologically transformed, the result is radioactive ¹⁴C-methane, or ¹⁴CH₄. Detection of radioactively labeled methane may be sensitive and specific, however, an exposure and contamination risk with radioactive isotopes may outweigh the sensitivity of using such an isotope. Accordingly, in some embodiments, the present technology may not use a radioactive isotope in any of the methods discussed.

An additional method for distinguishing new gas generation may utilize ¹³C, and following the transformation of a molecule with this isotope through the microbial process. However, there is a natural abundance of ¹³C of ˜1%, meaning that this method has limitations on sensitivity or identifying new gas generated relative to pre-existing amounts of material incorporating ¹³C. When measuring new methane, the natural abundance of ¹³CH₄ may in some instances be high enough to obscure any change due to a microbial stimulation. Deuterating a precursor, by switching one ¹H to ²H, also referred to as “D”, can eliminate the background issue with ¹³C. The natural abundance of ²H is ˜1:6,500, so there is less background interference using this isotope. Additionally, with aqueous treatments, D₂O may be substituted with water in a one-to-one ratio, which may facilitate use in treatments based on water delivery, such as described above. However, the use of stable isotopes may cause additional challenges.

Unlike the ¹⁴C tracers that can be used in analysis techniques with scintillation or other measures of radioactivity, stable isotopes must be distinguished using mass spectrometry (“MS”). For embodiments where methane may be a target produce, the identification may use a gas separation technique with MS detection. In general analysis, a compound can have its mass to charge ratio (m/z) determined to roughly a mass resolution of about 0.7, meaning that a mass to charge difference of one neutron can be measured. A single deuteron in a compound has a mass increase of 1, as does a single ¹³C. Hence, DCH₃ may not be distinguishable from ¹³CH₄ using standard analysis techniques. Accordingly, in some embodiments of the present technology enhanced identification techniques may be used to differentiate between ¹³CH₄ and DCH₃ within the produced materials. Notably, the amount of isotopically labeled precursor used may not be equivalent to a stimulatory treatment. Thus, the total number of isotopically labeled methane molecules made may not be the total number of moles of methane made by the community. Accordingly, in some embodiments a factor that may be used is the ratio of methanogenesis rates between a stimulated and unstimulated (natural) community. These techniques may operate on one or two metabolic pathways: methylotrophic or acetoclastic methanogenic activity of the microorganism community. As noted, these metabolic pathways may not afford enough sensitivity to reliably identify what may be newly produced material.

Because of these challenges, the present technology may be or include a process in which stable isotopes can be used as markers of biological activity in the environment, but at greater sensitivity than is possible using conventional or laboratory methods. This process may advantageously occur by a third methanogenic pathway, called hydrogenotrophic methanogenesis, which may use dissolved hydrogen and carbon dioxide within the formation environment to produce methane. Microbes may extract the majority of hydrogen used for this type of metabolic activity from water. Accordingly, in some embodiments, the addition of deuterium oxide, D₂O or ²H₂O, as the compound including the stable isotope, may allow the material to act as a stable isotope marker for hydrogenotrophic activity.

The resulting uptake of deuterium instead of hydrogen by microbes may result in a distribution of isotopically unique methane, primarily DCH₃. As previously noted, this compound may not be distinguishable by conventional gas chromatography-mass spectrometry from ¹³CH₄, which may be naturally included within the formation environment. Consequently, during identification operations, isotope ratio mass spectrometry, or a more advanced technique that allows for specific measurements of isotope ratios without other isotopic interference may be used. For example, cavity ring down spectroscopic detection may also be used to determine the isotope ratio of the resulting methane to allow a determination of the amount produced material resulting from increasing production of methane or other materials relative to pre-existing or otherwise produced materials, without interference from outer isotopologues.

The methods may also include providing one or more additional materials into the formation environment with the aqueous material. For example, a solution or mixture of materials incorporated within water, such as deionized water, may also be delivered. The materials included within the additional materials may include metals, salts, acids, and/or extracts. The salts or materials may be included in any hydrate variety, including monohydrate, dihydrate, tetrahydrate, pentahydrate, hexahydrate, heptahydrate, or any other hydrate variety. Exemplary materials may include metals or metallic compounds including one or more of cobalt, copper, manganese, molybdenum, nickel, tungsten, or zinc. Yeast extract may be included to provide further nutrients to the microorganisms and may include digests and extracts of commercially available brewers and bakers yeasts. A non-exhaustive list of materials that may be included in any amount or ratio include ammonium chloride, cobalt chloride, copper chloride, manganese sulfate, nickel chloride, nitrilotriacetic acid trisodium salt, potassium monophosphate, potassium diphosphate, sodium molybdate dihydrate, sodium tripolyphosphate, sodium tungstate, zinc sulfate, or some other phosphorus-containing compound, sodium-containing compound, sulfur-containing compound, or carboxylate-containing compounds, such as acetate and formate, for example.

The aqueous materials as well as any of the incorporated materials may be provided to the formation in a single amendment, or they may be provided in separate stages. For example, when both a compound including the stable isotope and additional materials are used, both the additional materials and the compound including the stable isotope may be incorporated within an aqueous material delivered into the formation environment. Additionally, separate aqueous materials may be delivered into the formation environment with one including the compound including the stable isotope, and another including the additional materials.

Whether the compound including the stable isotope and additional materials are introduced to the formation simultaneously or separately, they may be combined in situ and exposed to microorganisms. The combination of the hydrogen and materials can stimulate the microorganisms to increase methane or other material production, which can then be recovered from the geologic formation, or further utilized by the microorganisms.

In some embodiments the methods may also include measuring the concentration of methane or other target material prior to recovery of products from the formation environment. For gas phase metabolic products, the partial pressure of the product in the formation may be measured, while aqueous metabolic products may involve measurements of molar concentrations. Measurements may be made before providing the amendment, and a comparison of the product concentration before and after the amendment may also be made.

Additional operations that may be performed in some embodiments may include determining an amount of newly produced material from the formation environment. In order to differentiate an amount of in-situ material or pre-existing material relative to newly produced material, which may allow a quantification of renewably produced methane or other materials, a calculation may be performed. For example, prior to delivering the aqueous solution, a concentration of deuterium or some other stable isotope within in-situ hydrocarbons, such as methane, or other materials may be identified. Additionally, subsequent delivering the aqueous material, and in some embodiments after a period of time for consumption and generation, a concentration of deuterium or some other stable isotope within produced or recovered hydrocarbons, such as methane, or other materials may be identified. A determination of the amount of hydrocarbons or other materials resulting from increasing production within the formation environment may then be performed. For example, for a methane producing process, the following calculation may be performed:

$$V = \frac{( {C}_{mix} - {C}_{old} )}{{C}_{new} - {C}_{mix}} \times 100$$

Where V may be a relative abundance of methane resulting from the stimulation, C_{old} may be the concentration, such as in ppm, of deuterium or some other stable isotope in the in-situ methane prior to stimulation, C_{new} may be the concentration, such as in ppm, of deuterium or some other stable isotope in the produced methane from stimulation, and Cₘᵢₓ may be the concentration, such as in ppm, of deuterium or some other stable isotope in the produced methane collected, and which may be a combination of the two other concentrations. Cₘᵢₓ and Cold may be directly measured from gas samples collected from the treated field, whereas may be calculated based on the deuterium in the aqueous solution and the measured deuterium content of the water in the formation, which may provide a dilution factor of the aqueous solution.

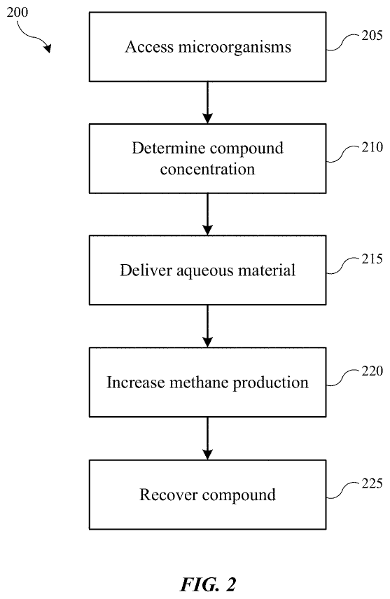

FIG. 2 illustrates exemplary operations in a method 200 for producing hydrocarbon materials from a geologic formation. Method 200 may include any of the operations, materials, or characteristics discussed previously with respect to method 100. For example, method 200 may include accessing microorganisms in a geologic formation that includes a carbonaceous material at operation 205. Measurements may be performed to detect, identify, or determine within the geologic formation a concentration of a material including a naturally occurring, stable isotope for one or more of the elements carbon, hydrogen, oxygen, nitrogen, or sulfur at operation 210. In some embodiments the element may not be a radioactive element.

Subsequent identification of the material, method 200 may include delivering an aqueous material into the reservoir at operation 215. The aqueous fluid may be characterized by or may include a compound including the naturally occurring, stable isotope for one or more of the elements carbon, hydrogen, oxygen, nitrogen, or sulfur. For example, a number of different compounds may be included or provided in embodiments of the present technology. In non-limiting examples encompassed by the present technology, the compound may be or include one or more of water, and the stable isotope may be ²H or ¹⁸O, carbon dioxide, and the stable isotope may be ¹³C or ¹⁸O, molecular hydrogen, and the stable isotope may be ²H, or acetic acid or its conjugate base, and the stable isotope may be ²H or ¹³C.

Method 200 may include increasing production within the reservoir or any of the previously-noted materials, such as methane or some other byproduct in which the stable isotope may be included, at operation 220. Subsequently, a produced material may be recovered from the reservoir at operation 225, which may at least partially include produced material including the naturally occurring, stable isotope for one or more of the elements carbon, hydrogen, oxygen, nitrogen, or sulfur. An analysis may then be performed as described above to determine a relative amount of material produced, which may be directly attributed to the stimulation performed, and which may represent a renewable amount of material, which may be subsequently produced again by repeating one or more operations of the method.

Identifying where stimulation may be performed may include any number of factors. For example, the stimulation or method may be performed in a region where production of material, such as methane or any other produce, may have decreased. This decrease in production may be indicative of a rollover effect. Rollover may be a condition where the rate of biogenic methane production starts to plateau as the in-situ methane concentration reaches a certain level. In many instances, the rate flattens to zero, and the methane concentration remains constant over time. The rollover point, or the point where the methane concentration may begin to break from a monotonically increasing state, may vary between microorganism consortia, but may be reached in almost all unamended environments of carbonaceous material that have been examined. By performing any of the noted processes or methods, rollover may be reversed to increase production of methane once again.

Uptake of the isotope may be affected by the formation environment through dilution by formation water or other materials. Accordingly, in some embodiments injection or delivery of the aqueous material may be provided to select locations of a reservoir or formation environment, which may be at least partially depleted in water. These locations may be readily available in coal-bed methane operation, as water pumping may be performed to cause the depressurization and release of the original gas reserve. Reservoir recharge can be observed and avoided to some extent, but in environments with significant water drives, D₂O usage as an isotope marker may be challenged. Accordingly, in some embodiments a formation environment analysis may be performed to determine an amount of in-situ formation water, as well as any other number of characteristics as will be discussed further below.

Coal maturation may afford smaller cleat volumes as a proportion of the total coal volume in the formation. This cleat volume may represent the entire space where biological activity takes place. The volume may also be the space that may be most likely to be contactable by an injection bolus of stimulation materials delivered. In very immature or extremely fractured coals, this volume may increase, meaning that the proportion of contacted microbes may decrease as compared to more mature coals. In some embodiments where the geologic formation may be or include a coal bed, additional analysis may be performed on the maturity of the coal to identify preferential regions. For example, coal maturity where the coal may have reached sub-bituminous levels of maturity may increase the effects of the methods with regard to resulting methane responses. A corollary to this principle may be that with the use of D₂O, any transport outside of the biologically relevant contacted surface area in cleats may result in losses, which may decrease biological transformation into detectable methane.

Deuterium may be used as the stable isotope in some embodiments as many coal seams have multiple biological fractionation events over geologic periods of time. This may result in significant depletion of deuterium. Coal is a biomass derived product, and thus the original biomass growth may have fractionated isotopes, favoring ¹H. In biogenic coal-bed methane reservoirs, the biodegradation of the coal may also favor ¹H over ²H. As a result, typical δD values, which may be parts per thousand differences from a reference standard, for biogenic methane may range from −150-450‰. Thus, a change of a few parts per million more deuterium than the environmental background may result in a measurable signal, and may result in improved accuracy and quantification of identified new gas produced.

The amount of any particular dosage of D₂O or other compound including a stable isotope may be included in an amount greater than a threshold to result in the generation of the desired product for measurement, such as DCH₃, in the subsurface at levels that can be detected using existing gas and liquid isotope ratio methods noted above. For deuterium-based treatments, a minimum enrichment of 1D:8000H in an injection of a bolus of stimulation chemicals may be sufficient to produce a measurable amount of enriched methane. In δD, this may be a value of approximately +1800‰ over the reference standard, although the total observed change may be relatively small due to the large dilution effect of water in the coal seam, as well as dilution due to the presence of isotopically depleted methane.

Any of the methods of the present technology may also include an analysis of the microorganism formation environment, which may include measuring the chemical composition that exists in the environment. This may include an in-situ analysis of the chemical environment, and/or extracting gases, liquids, and solid substrates from the formation for a remote analysis.

For example, extracted formation samples may be analyzed using spectrophotometry, NMR, HPLC, gas chromatography, mass spectrometry, voltammetry, and other chemical instrumentation. The tests may be used to determine the presence and relative concentrations of elements like dissolved carbon, phosphorous, nitrogen, sulfur, magnesium, manganese, iron, calcium, zinc, tungsten, cobalt and molybdenum, among other elements. The analysis may also be used to measure quantities of polyatomic ions such as PO₂³⁻, PO₃³⁻, and PO₄³⁻, NH₄⁺, NO₂⁻, NO₃⁻, and SO₄²⁻, among other ions. The quantities of vitamins, and other nutrients may also be determined. An analysis of the pH, salinity, oxidation potential (Eh), and other chemical characteristics of the formation environment may also be performed.

A biological analysis of the microorganisms may also be conducted. This may include a quantitative analysis of the population size determined by direct cell counting techniques, including the use of microscopy, DNA quantification, phospholipid fatty acid analysis, quantitative PCR, protein analysis, or any other identification mechanism. The identification of the genera and/or species of one or more members of the microorganism consortium by genetic analysis may also be conducted. For example, an analysis of the DNA of the microorganisms may be done where the DNA is optionally cloned into a vector and suitable host cell to amplify the amount of DNA to facilitate detection. In some embodiments, the detecting is of all or part of DNA or ribosomal genes of one or more microorganisms. Alternatively, all or part of another DNA sequence unique to a microorganism may be detected. Detection may be by use of any appropriate means known to the skilled person. Non-limiting examples include 16s Ribosomal DNA metagenomic sequencing; restriction fragment length polymorphism (RFLP) or terminal restriction fragment length polymorphism (TRFLP); polymerase chain reaction (PCR); DNA-DNA hybridization, such as with a probe, Southern analysis, or the use of an array, microchip, bead based array, or the like; denaturing gradient gel electrophoresis (DGGE); or DNA sequencing, including sequencing of cDNA prepared from RNA as non-limiting examples.

Additionally, the effect of the injected materials may be analyzed by measuring the concentration of a metabolic intermediary or metabolic product in the formation environment. If the product concentration and/or rate of product generation does not appear to be reaching a desired level, adjustments may be made to the composition of the amendment. For example, if a particular amendment of aqueous material does not appear to be providing the desired increase in methane production, dissolved hydrogen concentration may be adjusted within the aqueous fluid, or additional or alternative metals or other materials may be incorporated within the aqueous fluid.

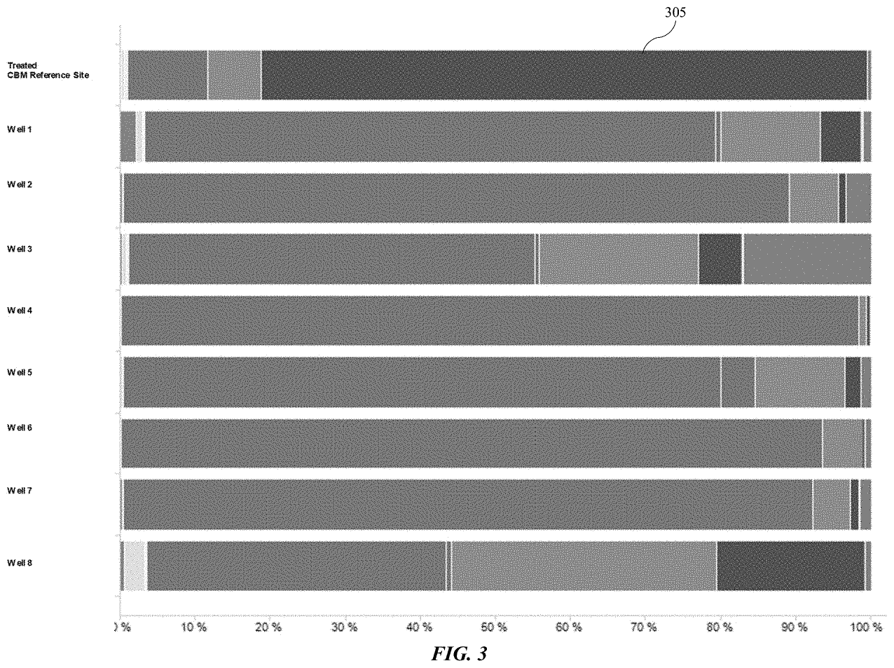

Turning to FIG. 3 is shown a chart illustrating a DNA sequencing profile for a microbial community within a formation environment according to some embodiments of the present technology. In the figure, the archaeal profile is shown. Regions shaded similar to section 305 may represent archaeal species that may directly use materials provided or delivered to a formation environment as noted previously to produce methane. After a treatment, such as any of the treatments or aspects of treatments described above, that metabolic pathway may be the dominant pathway observed, as illustrated in the top bar for a reference treated well. The rest of the wells illustrated were dominated by the hydrogenotrophic pathway as described above, except for well 8.

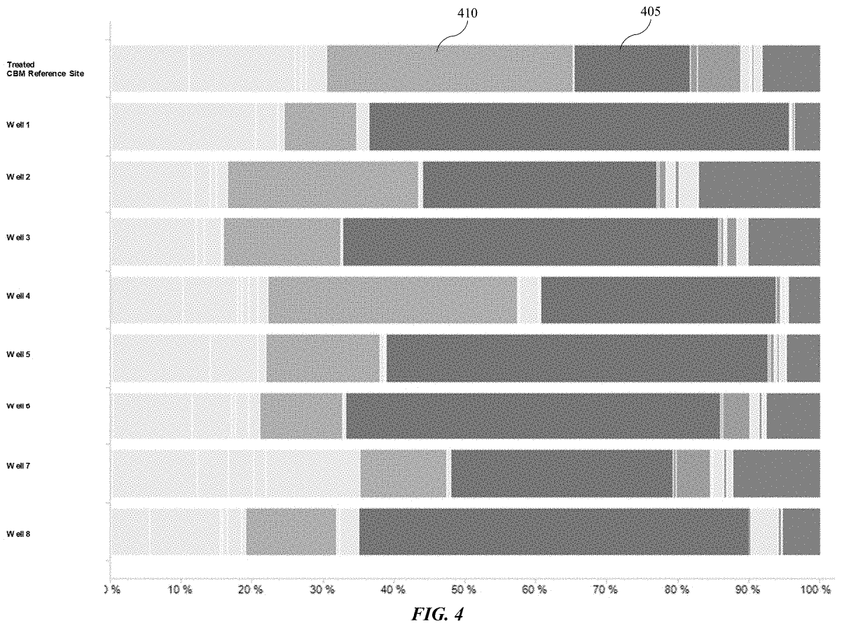

FIG. 4 is a chart illustrating another DNA sequencing profile for a microbial community within a formation environment according to some embodiments of the present technology. Two groups of microorganisms are identified in this chart. Regions shaded similar to section 405 may illustrate a portion of the community representing traditional fermentative eubacteria, which may facilitate the biodegradation process. The regions shaded similar to section 410 may also illustrate a portion of the community representing fermentative bacteria, however these species may be more likely to form syntrophic partnerships with methanogens to produce a beneficial metabolic arrangement, and which may further benefit from exposure to treatment materials described above. Finding these relationships may identify locations where a greater amount of methane or other materials may be produced using methods according to embodiments of the present technology. By utilizing aspects of the present technology, renewable methane and other material resources may be stimulated and utilized.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a material” includes a plurality of such layers, and reference to “the amendment” includes reference to one or more precursors and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A method of producing hydrocarbon materials from a geologic formation, the method comprising:
accessing a consortium of microorganisms in a geologic formation that includes a carbonaceous material;
delivering an aqueous material incorporating deuterium oxide to the consortium of microorganisms;
increasing production of hydrocarbon materials by the consortium of microorganisms; and
recovering a deuterium-containing hydrocarbon from the geologic formation.

2. The method of producing hydrocarbon materials from a geologic formation of claim 1, wherein the deuterium-containing hydrocarbon comprises a deuterium-containing methane.

3. The method of producing hydrocarbon materials from a geologic formation of claim 1, further comprising:
determining an amount of newly produced gaseous materials.

4. The method of producing hydrocarbon materials from a geologic formation claim 3, wherein the determining comprises:
identifying a concentration of deuterium within in-situ hydrocarbons prior to delivering the aqueous material,
identifying a concentration of deuterium within recovered hydrocarbons, and
determining an amount of hydrocarbons resulting from increasing production of the hydrocarbon materials.

5. The method of producing hydrocarbon materials from a geologic formation of claim 4, further comprising:
differentiating between ¹³CH₄ and DCH₃ within the hydrocarbons.

6. The method of producing hydrocarbon materials from a geologic formation of claim 5, wherein the differentiating is performed with isotope ratio mass spectrometry or cavity ring down spectroscopic detection.

7. The method of producing hydrocarbon materials from a geologic formation of claim 1, wherein the aqueous material further comprises incorporated metals.

8. The method of producing hydrocarbon materials from a geologic formation of claim 7, wherein the incorporated metals include one or more of cobalt, copper, manganese, molybdenum, nickel, tungsten, or zinc.

9. The method of producing hydrocarbon materials from a geologic formation of claim 1, wherein the aqueous material further comprises yeast extract.

10. The method of producing hydrocarbon materials from a geologic formation of claim 1, wherein the aqueous material comprises a phosphorous-containing compound.

11. The method of producing hydrocarbon materials from a geologic formation of claim 1, wherein the geologic formation comprises a coal bed, and wherein the aqueous material is delivered into a cleat characterized by a sub-bituminous coal maturity.

12. A method of producing hydrocarbon materials from a geologic formation, the method comprising:
accessing a consortium of microorganisms in a geologic formation that includes a carbonaceous material;
determining a concentration of deuterium of in-situ methane within the geologic formation;
delivering an aqueous material incorporating a deuterium-containing compound to the consortium of microorganisms;
increasing production of methane by the consortium of microorganisms; and
recovering a deuterium-containing methane from the geologic formation.

13. The method of producing hydrocarbon materials from a geologic formation of claim 12, further comprising:
determining a concentration of deuterium in the recovered deuterium-containing methane.

14. The method of producing hydrocarbon materials from a geologic formation of claim 13, further comprising:
determining a volume of new methane produced by the method.

15. The method of producing hydrocarbon materials from a geologic formation of claim 12, wherein the geologic formation is a deposit comprising oil, natural gas, coal, bitumen, tar sands, lignite, peat, carbonaceous shale, or sediments rich in organic matter.

16. The method of producing hydrocarbon materials from a geologic formation of claim 12, further comprising:
differentiating between ¹³CH₄ and DCH₃ within the deuterium-containing methane.

17. The method of producing hydrocarbon materials from a geologic formation of claim 12, wherein the aqueous material further comprises incorporated metals, yeast extract, or a phosphorus-containing compound.

18. A method of producing hydrocarbon materials from a geologic formation, the method comprising:
accessing a consortium of microorganisms in a geologic formation that includes a carbonaceous material;
determining within the geologic formation a concentration of a material including a naturally occurring, stable isotope for one or more of the elements carbon, hydrogen, oxygen, nitrogen, or sulfur of in-situ methane;
delivering to the consortium of microorganisms an aqueous material incorporating a compound including the stable isotope for the one or more of the elements carbon, hydrogen, oxygen, nitrogen, or sulfur;
increasing production of a compound by the consortium of microorganisms; and
recovering from the geologic formation the material produced including the stable isotope for the one or more of the elements carbon, hydrogen, oxygen, nitrogen, or sulfur.

19. The method of producing hydrocarbon materials from a geologic formation of claim 18, wherein the compound comprises:
water, and the stable isotope is ²H or ¹⁸O,
carbon dioxide, and the stable isotope is ¹³C or ¹⁸O,
molecular hydrogen, and the stable isotope is ²H, or
acetic acid or its conjugate base, and the stable isotope is ²H or ¹³C.

20. The method of producing hydrocarbon materials from a geologic formation of claim 18, wherein the produced material comprises methane, carbon dioxide, or hydrogen comprising the stable isotope.
